(19) United States
(12) Patent Application Publication
(10) Pub. No.: US 2008/0298108 A1
(43) Pub. Date: Dec. 4, 2008

(54) COMPONENT CONSTRUCTION WITH SWITCHING POWER SUPPLY ACTUATES MODULE AND APPLICATION CONCEPT

(75) Inventor: Jia Hua Hu, Hong Kong (CN)

Correspondence Address: AKERMAN SENTERFITT, P.O. BOX 3188, WEST PALM BEACH, FL, 33402-3188, US

(73) Assignee: Hyperup Group Limited, Hong Kong (CN)

(21) Appl. No.: 12/050,214

(22) Filed: Mar. 18, 2008

(30) Foreign Application Priority Data
May 29, 2007 (HK) 07105727.2

(51) Int. Cl. H02M 1/10

(52) U.S. Cl. 363/147

(57) ABSTRACT

A component construction with switching power supply actuates module use for stabilize voltage on/off to achieve high efficiency energy saving. With the remains of resonance electric wave form drive by vibration to make it not follow the voltage input and the changes of the electric wave load effect to stabilize voltage. In the meanwhile, when improve the electric wave form it can solve and reduce to the minimum of the high frequency harmonic wave for radiation between space. Using monitor control circuit, compare over voltage and under voltage for reference to command the voltage input and output during the current changing process and make sure the circuit power output and the electric wave are sine wave. There will be more perfect sine power driving appear on the new model module to achieve saving energy. The new module design in light weight and compact size, aside from high efficiency energy saving, it also use in both commercial and residential with changing AC to DC, AC to AC and DC to AC functions can use in different kinds of industrial and household appliance. Especially in computer, acoustic equipment, electric lamp, air conditioner, motor, elevator, arm rest elevator, electric heating water boiler and electric appliance power plug-in outlet. This module will have great potential in the future market.

### BACKGROUND OF THE INVENTION

1. Field of Invention

The present invention relates to a switch regulated power supply product which has universal high efficiency and energy conservation, and stably outputs voltage without the influence of the change of input voltage and load current under being driven by a resonant type of current waveform, and the combinational circuit is driven more perfectly to achieve the purpose of high efficiency and energy conservation.

2. Description of Prior Art

The present invention resolves or reduces high order radiation towards the space greatly less while improving the waveform, by employing monitor control circuit over voltage current and under voltage current reference, instructing to ensure that the output power of the circuit and the waveform of the current are sine waves during the changing process of the working input and output voltage and current to combine more perfect sine driving power to occur in the new type module circuit. The design of the present invention is simple and portable, and the cost for producing it is low. Except for its high efficiency and energy conservation, it also can be applied for civil use or commercial use. It is provided with 12 pins, 16 pins, 24 pins and a function of transforming from the alternating current (AC) to the direct current (DC), from one alternating current (AC) to another alternating current (AC) and from direct current (DC) to alternating current (AC). So it is adapted to various industrial and household products and the potential market is very considerable.

### SUMMARY OF THE INVENTION

In the 21^{st} century, the principal of the current switch regulated power supply is that the continuous direct current is transformed into pulse current that supply power discontinuously by the switch action of the transistors, and then the discontinuous pulse current is transformed into direct current by a energy store assembly. Output voltage may be changed by the switch time, and thus if the switch time is controlled by the output voltage change, the voltage output is stabilized.

There are many types of switch regulated power supply products in the market and the difference between their performances is great. Normal operation mostly is in the band from 60 to 500 KHz. As it is well known, improving the switch frequency may more efficiently exhibit the advantages and more efficiently suppress the ripple coefficients. But the same difficult problem which they suffer from is the speed limit from the switch. It is difficult to work in the band of 500 KHz and can not improve the frequency of the switch regulated power supply, even if the base region is made much thinner to reduce the electron loss.

At present it is replaced by Field Effect Transistor switch or Schottky switch. Such switches can work with the product fittings beyond the band of 300 KHz to 3 MHz. But if it wants to work in the band of 5 MHz to more efficiently suppress the ripple and to reduce the volume and weight, the switch should be selected more seriously, therefore improving the cost, or the chip is controlled to resolve it's response, and with the aid of low cost switch and output power or inductance line member it makes the newest fifth generation products. But the switch regulated power supply device developed by the conditions above although may improve the frequency of the switch regulated power supply, reduce the volume and the weight, increase the power and effectively reduce ripples, and so on, but there still are many filed where such switch regulated power supply is not adapted to be provided, due to the waveform disturbance resulted therefrom. Manufactures in different countries design circuit to resolve the problem of waveform disturbance, most of them employ series resonance circuit and parallel resonance circuit that resonance on the fundamental wave, or employ pulse output electrical wire inductance as coupling member, resulting in that the load loop of the switch become into the resonance loop. The current waveform in the form of resonance makes that the load current have very great changes with the input voltage, and the relationship between the pulse width and output voltage can not be measured. If such problem can be resolved, it will become the sixth generation universal switch regulated power supply product.

The objective of the present invention is to solve the waveform disturbance described above and to improve the frequency of the switch regulated power supply. According to Fourier theorem, it can filter the third order harmonic wave by the output sine current to resolve problems of the waveform disturbance while holding the fundamental wave. It resolves or reduces the greatly least high order harmonic wave radiated to the space while improving the waveform, by employing monitor control circuit, over voltage current and under voltage current reference, instructing to ensure that the output power of the circuit and the waveform of the current are sine waves during the changing process of the working input and output voltage and current to combine more perfect sine driving power to occur in the new type module circuit. While holding the resonance type of current waveform surge driver, it stably outputs voltage without the influence of the input voltage and load current changes, and develops more perfect driver assembled circuit devices.

The present invention is a kind of new assembled assembly switch power supply driver circuit module, which responds to the band of 3-4 MHz, has over voltage current, under voltage current, stable pulse driver, arbitrarily set output, pulse width setting, built in optical fiber reference regulated power supply, load current and detected signal input of waveform stably disturbed voltage, and which can directly drive the IGBT transistor module with maxim current of 100 A. Through the driver device designed by the present invention, and with aid of IGBT transistor module and peripheral circuit assembly, it can make that the switch regulated power supply has products with better sine waveform output and switch driving ability. Its volume is a quarter of the same kind of 800-1000 W product in size, and its weight is less than 200 grams.

The 16 pins of the assembled assembly switch power supply driver module of the present invention are applied to the sixth switch regulated voltage power supply products, which makes the designment simple and portable and reduces cost. Besides this, the product gives perfect waveform to the load current, the coil can use any electric conduction metal wire for reduce current waveform disturbance. It reduces the electric energy consumed by the employed material. Except for its high efficiency and energy conservation of the present invention, it also can be applied to civil use or commercial use. Besides 16 pins, it is provided with 12 pins, 24 pins and a function of transforming from the alternating current to the direct current. So it is adapted to various industrial and household products, especially to the products of computers, acoustics devices, electric lights, air conditionings, motor, elevator, moving staircase, electric water heaters and electrical outlets.

The present invention will be illustrated in detail by reference to the figures taken in conjunction with the embodiment to further understand the features and advantages of the present invention.

### BRIEF DESCRIPTION OF THE DRAWINGS

FIG. 1 shows the circuit diagram of the assembled assembly switch power supply driver module;

FIG. 2 shows the flowchart of the assembled assembly switch power supply driver module; and

FIG. 3 shows the pin function assignment diagram of the assembled assembly switch power supply driver module.

### DETAILED DESCRIPTION OF PREFERRED EMBODIMENTS

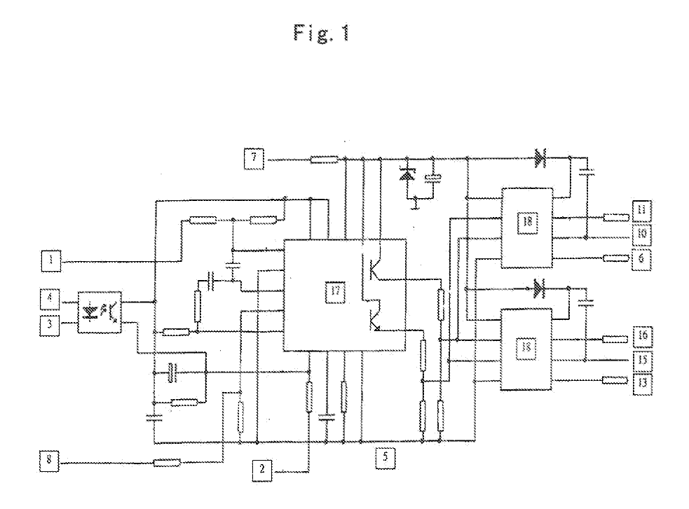

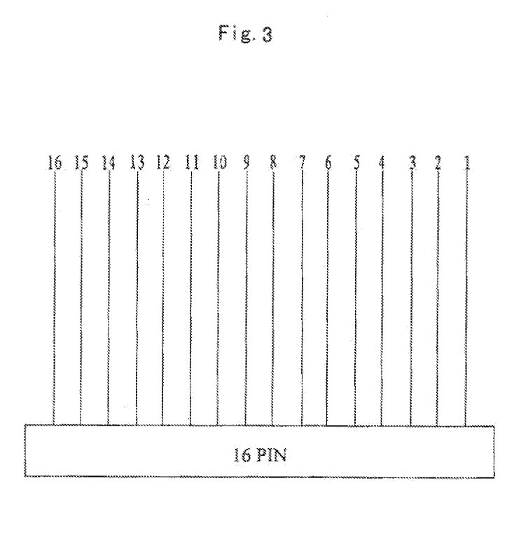

The circuit diagram of the assembled assembly switch power supply driver module and the module's 16 pins function assignment diagram as shown in FIG. 1 and FIG. 3 the assembly and 16 pin function include input power control (1), pulse width setting (2), regulated voltage controlled optical fiber K (3), regulated voltage controlled optical fiber A (4), ground wire (5), a bottom right driver output (6), working voltage 15V-18V (7), output current control (8), floated pin (9), midpoint of a top right driver (10), a top right driver output (I 1), ground wire (12), a bottom left driver output (13), floated pin (14), midpoint of a top left driver (15), a top left driver output (16), integrated circuit 494 (17), integrated circuit 21 (18).

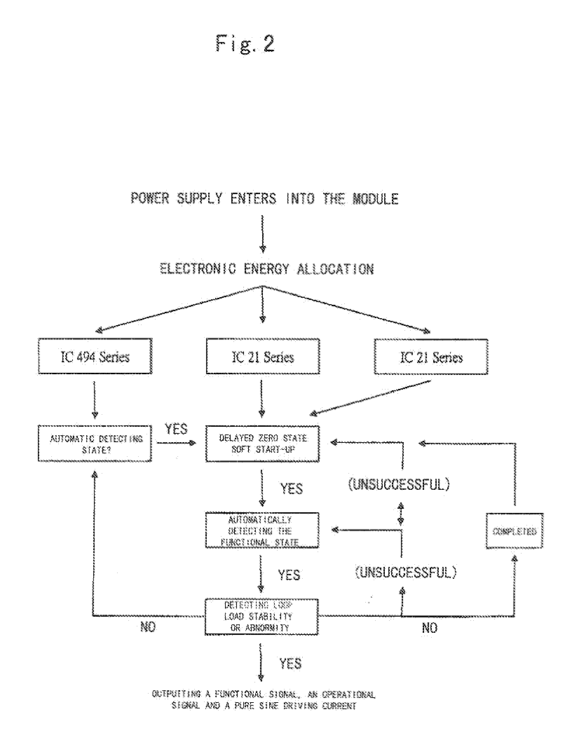

In the flowchart of the assembled assembly switch power supply driver module as shown in FIG. 2, when the power supply enters into the module, it will be assigned to three part of integrated circuits, where is one integrated circuit 497 (17) and two integrated circuits 21 (18). The integrated circuit 494 (17) will enter into automatic detecting circuit to be an automatic detecting state when it collects the power supply, which automatic detecting range is mainly for whether the outer circuit has influence on the disturbance, under voltage, over voltage, and short circuit of current. If the automatic detecting is completed and the result is good, the current is transferred to the soft start-up in a delayed zero state. If the detected state is not good, the current will be kept in the automatic detecting circuit until the result of state becomes good.

The delayed soft start-up mode is mainly for the adjustment to the desired voltage and frequency for various electrical appliances by the current, but it doesn't provide additional output resulting in overheat and wasting of electric energy and it can provide perfect and appropriate voltage and frequency to achieve energy consumer effect. For example, if the module is applied to acoustics devices, the acoustics devices require current of high level and low frequency, so that the tone will not be distorted when it is played d. So when the power supply is input into the module, appropriate adjustment is made by the automatic detecting of the function and state to reach the requirement of high voltage level and low frequency, and the event that will be effective when the coordinate reaches zero is performed automatically by zero state soft start-up of delay to provide working current with perfect and appropriate voltage and frequency.

After the automatic detection of the functional state is completed, finally the stability detection of loop load or abnormity detection are performed. After it is measured, it will output successfully a functional signal, an operational signal and a pure sine driving current to be applied to various industrial and household appliances. If the current fails to pass the measurement of loop load stability or abnormity, the current will return to the automatic detecting circuit to be detected repeatedly, suffering from delayed zero state soft start-up stage until it passes the automatic detection of the function and the detection of loop load stability or abnormity and the result is good.

As much, after the power supply is assigned to the integrated circuit 21 (18), it also suffer from the zero state soft start-up stage of delay until it passes the automatic detecting of the function and the detecting of loop load stability or abnormity and the result is good to output functional signals, operational signals and pure sine driving current to be supplied.

What is claimed is:

1. A type of assembled assembly switch power supply driver module, which is applied to switch regulated voltage power supply products, and has the purpose of energy conservation, resolve waveform disturbance, enhance voltage constant frequency, ensure the waveform of current are sine waves, wherein the assemble assembly switch power supply driver module comprises an input power control, pulse width setting, regulated voltage controlled optical fiber K, regulated voltage controlled optical fiber A, ground wire, a bottom right driver output, working voltage 15V-18V, output current control, floated pin, midpoint of a top right driver, a top right driver output, ground wire, a bottom left driver output, floated pin, midpoint of a top left driver, a top left driver output, integrated circuit 494, integrated circuit 21.

2. The assembled assembly switch power supply driver module according to claim 1, wherein after the power supply enters into integrated circuit 494 and two integrated circuits 21 to detect whether the current is influenced by disturbances, under voltage, over voltage, and short circuit.

3. The assembled assembly switch power supply driver module according to claim 1, wherein when the current enter the coordinates reaching zero will automatic start-up charging.

4. The assembled assembly switch power supply driver module according to claim 1, wherein the module is provided with an automatic detecting system of the functional state, loop load stability and abnormity detection, which is adjusted the desire voltage and frequency of various electric appliance design for the current without making additional output, ensure voltage constant frequency to reduce electric power waste.

5. The assembled assembly switch power supply driver module according to claim 4, wherein the power supply passes various detecting system, and if the result of detecting is good, it will outputs a functional signal, an operational signal and a pure sine driving current to be supplied.

6. The assembled assembly switch power supply driver module according to claim 5, wherein the power supply passes various detecting systems, and if the result of detection is not good, it will return to the automatic detecting circuit and repeat the detection of various detecting systems until the result of state becomes good.

7. The assembled assembly switch power supply driver module according to claim 1, wherein it remains the resonant type of current waveform and stably outputs voltage without the influence of the change of the input voltage and the load current ensure the waveform of current are sine waves.

8. The assembled assembly switch power supply driver module according to claim 7, wherein it resolves or reduces high order radiation towards the space greatly less while improving the waveform, by employing monitor control circuit, over voltage current and under voltage current reference, instructing to ensure that the output power of the circuit and the waveform of the current are sine waves during the changing process of the working input and output voltage and current to combine more perfect sine driving power to occur in the new type module circuit to achieve the effect of energy conservation.

9. The assembled assembly switch power supply driver module according to claim 8, wherein according to Fourier theorem, it filters the third order harmonic wave by the output sine current to resolve problems of the waveform disturbance while holding the fundamental wave.

10. The assembled assembly switch power supply driver module according to claim 1, wherein which responds to the band of 3-4 MHz, has over voltage current, under voltage current, stable pulse driver, arbitrarily set output, pulse width setting, built in optical fiber reference regulated power supply, load current and detected signal input of waveform stably disturbed voltage, and which directly drives the IGBT transistor module with maxim current of 100 A.

11. The assembled assembly switch power supply driver module according to claim 10, wherein through the driver device and with aid of IGBT transistor module and peripheral circuit assembly, it makes that the switch regulated power supply has products with better sine waveform output and switch driving ability.

12. The assembled assembly switch power supply driver module according to claim 1, wherein the 16 pins assignment used of the circuit module comprise an input power control, pulse width setting, regulated voltage controlled optical fiber K, regulated voltage controlled optical fiber A, ground wire, a bottom right driver output, working voltage 15V-18V, output current control, floated pin, midpoint of a top right driver, a top right driver output, ground wire, a bottom left driver output, floated pin, midpoint of a top left driver, a top left driver output.

13. The assembled assembly switch power supply driver module according to claim 1, wherein the product gives perfect waveform to the load current, the coil can use any electric conduction metal wire for reduce current waveform disturbance.

14. The assembled assembly switch power supply driver module according to claim 1, wherein it can be applied to civil use or commercial use and it is provided with a function of transforming from the alternating current to the direct current and it is adapted to various industrial and household products, especially to the products of computers, acoustics devices, electric lights, air conditionings, motor, elevator, moving staircase, electric water heaters and electrical outlets.
